(19) United States
(12) Patent Application Publication
(10) Pub. No.: US 2006/0145611 A1
(43) Pub. Date: Jul. 6, 2006

(54) Method for manufacturing opaque electrodes of a plasma display panel, mold plate used in the same, and plasma display panel with opaque electrodes manufactured thereby

(75) Inventors: Kyu-Nam Joo, Suwon-si (KR); Kyung-Nam Choi, Suwon-si (KR); Hyun-Ki Park, Suwon-si (KR); Dong-Hee Han, Suwon-si (KR)

Correspondence Address: LEE & MORSE, P.C., 1101 WILSON BOULEVARD, SUITE 2000, ARLINGTON, VA, 22209, US

(73) Assignee: Samsung SDI Co., Ltd.

(21) Appl. No.: 11/298,991

(22) Filed: Dec. 12, 2005

(30) Foreign Application Priority Data
Dec. 11, 2004 (KR) 10-2004-0104649

(51) Int. Cl. H01J 9/24; H01J 17/49

(52) U.S. Cl. 313/582; 445/24

(57) ABSTRACT

A method of manufacturing opaque electrodes of a plasma display panel includes providing a mold plate having plating grooves corresponding to patterns of the opaque electrodes of the plasma display panel, forming first plating layers in the plating grooves, transferring the first plating layers to display electrodes on a substrate and removing the mold plate, leaving the first plating layers on the display electrodes. There may be adhesive between the display electrodes and the first plating layer. There may be a second plating layer between the display electrode and the first plating layer.

### BACKGROUND OF THE INVENTION

1. Field of the Invention

The present invention relates to a method for manufacturing opaque electrodes of a plasma display panel, a mold plate used in the same and a plasma display panel with opaque electrodes manufactured thereby. More particularly, the present invention relates to a method for manufacturing opaque electrodes of a plasma display panel using a mold plate to improve productivity and a plasma display panel with the opaque electrodes manufactured thereby.

2. Description of the Related Art

Plasma display panels are flat display panels that form an image using a gas discharge phenomenon. Plasma display panels can be used to provide a large screen, having a high picture quality, which is thin and has a wide viewing angle. Thus, there is much interest in plasma display panels.

Plasma display panels include first and second substrates, which face each other and are spaced apart by a predetermined gap, barrier ribs defining a discharge cell disposed between the first and second substrates, a discharge gas filling the discharge cell, a phosphor coating the surface of the discharge cell, and electrodes. The electrodes include a plurality of display electrode pairs on the first substrate and a plurality of address electrodes on the second substrate. The address electrodes extend across the display electrode pairs and the discharge cell. When a direct current (DC) or an alternating current (AC) is applied to the electrodes, discharge occurs in the discharge cell, causing the discharge gas to emit ultraviolet (UV) light, thereby exciting the phosphor to emit visible light, thus forming an image.

FIG. 1 illustrates a schematic exploded perspective view of an AC type plasma display panel. Referring to FIG. 1, a pair of transparent X and Y display electrodes 3 and 4 are formed on an inner surface of a front glass substrate 11, and address electrodes 5 are formed on an inner surface of a rear glass substrate 12. A dielectric layer 14 and a protection layer 15 are sequentially formed on the inner surface of the front glass substrate 11. Barrier ribs 17 are formed on upper surface of a dielectric layer 14′ on the rear glass substrate 12 and define a plurality of discharge cells 19. A discharge gas fills the discharge cells 19. Fluorescent materials 18 are provided in the discharge cells 19. Bus electrodes 6 are formed on surfaces of the X and Y display electrodes 3 and 4, and prevent an increase in a line resistance associated with an increased length of the X and Y display electrodes 3 and 4.

FIG. 2 illustrates a schematic perspective view of another front glass substrate of a plasma display panel that has been inverted. In this embodiment, a front glass substrate 21 further includes black electrodes. The rear glass substrate to be used with the front glass substrate 21 may be as shown in FIG. 1.

Referring to FIG. 2, X and Y display electrodes 23 and 24 are formed on an inner surface of the front glass substrate 21, and black electrodes 29 are formed on the X and Y display electrodes 23 and 24. The black electrodes 29 prevent cross-talk between pixels, thereby improving contrast, and prevent an increase in a line resistance associated with an increased length of the X and Y display electrodes 23 and 24. Bus electrodes 25 are formed on the black electrodes 29, and further prevent increases in the line resistance of the X and Y display electrodes 23 and 24. A dielectric layer 27 and a protection layer 26 are also provided on the front glass substrate 21.

FIGS. 3A through 3D illustrate cross-sectional views in a general method of forming black electrodes and bus electrodes. Referring to FIG. 3A, a photosensitive film 31, e.g., Ag, is printed on a surface of a front glass substrate 21 on which X and Y display electrodes 23 and 24 have been formed in a previous process. The photosensitive film 31 includes a black pigment. The photosensitive film 31 is coated on the entire surface of the front glass substrate 21. Referring to FIG. 3B, the photosensitive film 31 is dried using a dryer 32. Air ventilated through the dryer 32 promotes the drying of the photosensitive film 31. Referring to FIG. 3C, a mask 33 is disposed above the front glass substrate 21 and light 34 is incident thereon to expose the photosensitive film 31. A portion of the photosensitive film 31 a not covered by the mask 33 is hardened by the exposure. After the exposure is finished, as shown in FIG. 3D, the hardened photosensitive film 31 is developed to form black electrodes 29 on the X and Y display electrodes 23 and 24 and the remaining portion of the photosensitive film 31 is removed. The black electrodes 29 are completed through a firing process. The processes described with reference to FIGS. 3A through 3D may be equally applied with respect to bus electrodes. However, the photosensitive film 31 used to form the bus electrodes does not include a black pigment.

In the method of manufacturing the black and bus electrodes as illustrated in FIG. 3A through 3D, while a photosensitive film is coated on an entire surface of a front glass substrate, only a portion thereof is used to form the black or bus electrodes. The remaining portion of the photosensitive film is removed. Thus, a lot of the photosensitive film is wasted in this process.

As an alternative to the above-described method, a sputtering method may be used to form bus and black electrodes, but sputtering is more expensive than printing. Also, bus and black electrodes may be directly printed using a screen mask. However, since a line width of the bus electrodes is within a range between 50 μm and 100 μm, the bus electrodes cannot be readily made using a screen mask.

As an alternative to photosensitive Ag with black pigment, the black electrodes may be formed of photosensitive RuO₃. However, the photosensitive RuO₃ is more expensive than photosensitive Ag, and suffers from the same waste issues as the photosensitive Ag.

### SUMMARY OF THE INVENTION

The present invention is therefore directed to a method of manufacturing an improved plasma display panel, a mold plate used in the same, and a plasma display panel with opaque electrodes manufactured thereby, which substantially overcome one or more of the problems due to the limitations and disadvantages of the related art.

It is a feature of an embodiment of the present invention to provide a method of manufacturing a plasma display panel, a mold plate used in the same, and a plasma display panel with opaque electrodes manufactured thereby, which reduces an amount of material used for the formation of the opaque electrodes.

It is another feature of an embodiment of the present invention to provide a method of manufacturing a plasma display panel, a mold plate used in the same, and a plasma display panel with opaque electrodes manufactured thereby, which simplifies the manufacture of the opaque electrodes.

At least one of the above and other features and advantages of the present invention may be realized by providing a method of manufacturing including providing a mold plate having plating grooves corresponding to patterns of the opaque electrodes of the plasma display panel, forming first plating layers in the plating grooves, transferring the first plating layers to display electrodes on a substrate, and removing the mold plate, leaving the first plating layers on the display electrodes.

The first plating layers may be Ag plating layers. The mold plate may include a metal film on a material plate, wherein the plating grooves are on the metal film. The metal film may be one of stainless steel, titanium, nickel and iron. Providing the mold plate may include forming a seed layer for electroless plating before forming the first plating layers. The plating grooves may be formed in a photoresist. The mold plate may include a glass material plate or a plastic material plate. The plating grooves may be formed by a photoresist paste. The method may further include providing an adhesive material between the first plating layers and the display electrodes before transferring.

The method may further include, before transferring, forming second plating layers on upper surfaces of the first plating layers, the transferring including transferring the first and second plating layers. The first plating layers may be Ag plating layers, and the second plating layers may be copper or Ni—P plating layers. The method may further include, before transferring, blackening the second plating layers. When, the second plating layers are copper plating layers, the blackening may include using an alkaline blackening solution. When the second plating layers are Ni—P plating layers, the blackening may include using an acid blackening solution.

At least one of the above and other features and advantages of the present invention may be realized by providing a mold plate used for manufacturing opaque electrodes of a plasma display panel, the mold plate including a plate and patterns formed on an upper surface of the plate including plating grooves corresponding to the opaque electrodes of the plasma display panel.

The plate may be one of a plastic plate, a plastic plate having a metal layer thereon, a glass plate and a ceramic plate. The patterns may be formed of one of a photoresist and a photosensitive glass paste.

At least one of the above and other features and advantages of the present invention may be realized by providing a plasma display panel, including display electrodes, bus electrodes and an adhesive material between the display electrodes and the bus electrodes. The plasma display panel may include black electrodes between the adhesive material and the bus electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic exploded perspective view of a general plasma display panel;

FIG. 2 illustrates a schematic perspective inverted view of another front glass substrate;

FIGS. 3A through 3D illustrate cross-sectional views of stages in a method of forming black and bus electrodes;

FIGS. 4A through 4D illustrate cross-sectional views of stages in a method of manufacturing a mold plate used in a method of manufacturing bus electrodes of a plasma display panel according to an embodiment of the present invention;

FIG. 5 illustrates a schematic perspective view of a mold plate formed using the method of FIGS. 4A through 4D; and

FIGS. 6A through 6E illustrate schematic cross-sectional views of stages in a method of manufacturing bus and black electrodes using a mold plate.

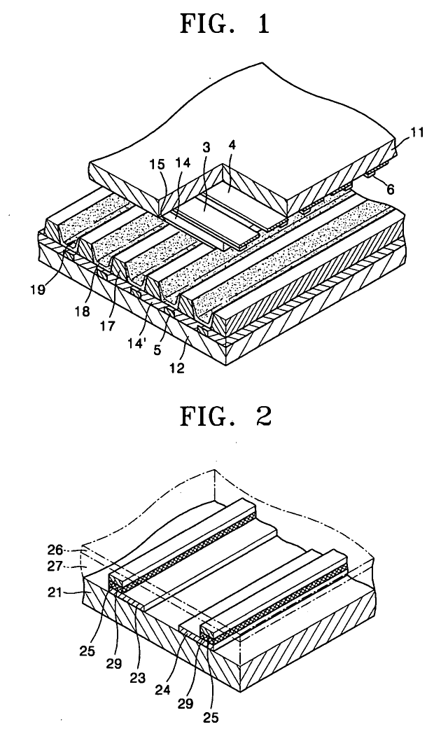

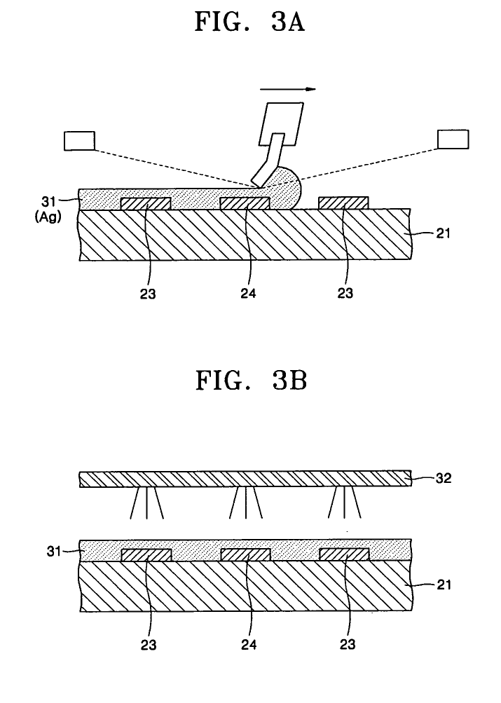

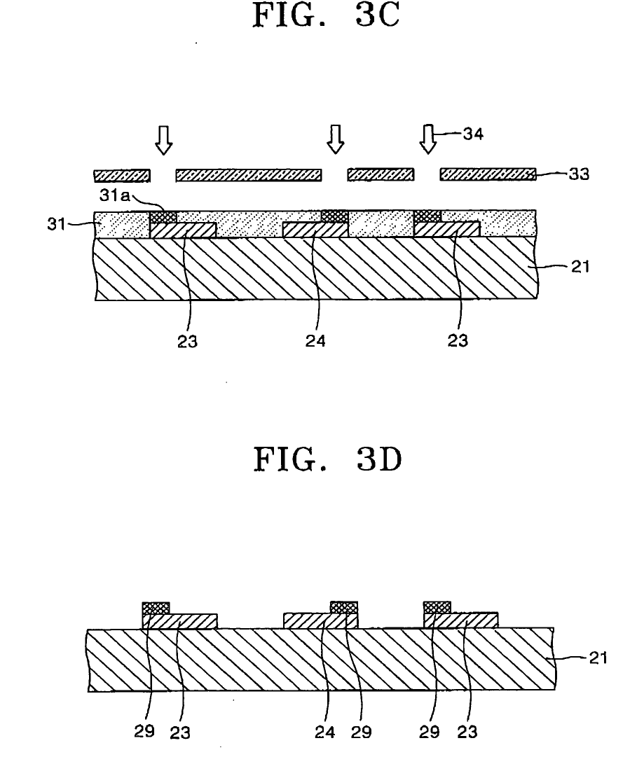

### DETAILED DESCRIPTION OF THE INVENTION

Korean Patent Application No. 10-2004-0104649, filed on Dec. 11, 2004, in the Korean Intellectual Property Office, and entitled, “Method for Manufacturing Bus Electrode of Plasma Display Panel, Mold Plate Used in the Same Method, and Plasma Display Panel with Bus Electrode Manufactured Thereby,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A method of manufacturing opaque electrodes of a plasma display panel according to an embodiment of the present invention may be performed using a mold plate. After opaque electrodes, e.g., black and/or bus electrodes, are formed on the mold plate in predetermined patterns, they may be transferred from the mold plate and secured to display electrodes on a front glass substrate.

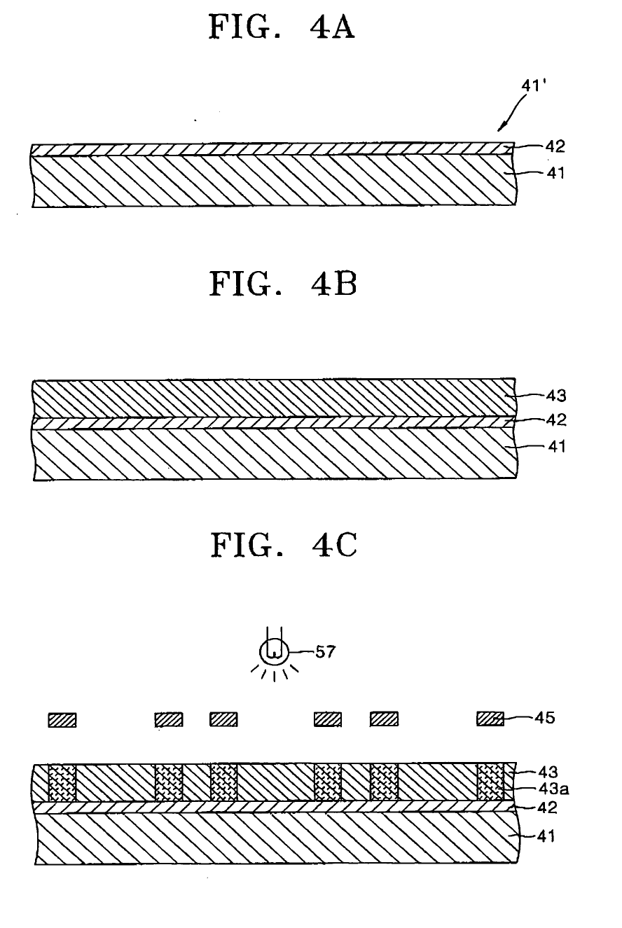

FIGS. 4A through 4D illustrate cross-sectional views of stages in a method of manufacturing a mold plate 40 used in a method of manufacturing bus electrodes of a plasma display panel according to an embodiment of the present invention. Referring to FIG. 4A, a metal thin film 42 may be provided on an upper surface of a plastic substrate 41 to form a plate 41′. The plastic substrate 41 may be formed of a flexible material, e.g., ABS, and may help strengthen the mold plate 40 of FIG. 4D. The plastic substrate 41 may be bent to easily transfer bus and black electrodes, as described later. The metal thin film 42 may serve as a seed layer during plating of the bus and black electrodes. The bus and black electrodes on the metal thin film 42 are preferably easily separated from the metal thin film 42 during transfer. Thus, the metal thin film 42 may be formed of a material that may be readily released from the material forming the electrodes, e.g., stainless steel, titanium, nickel, iron, etc.

Alternatively, the mold plate 40 may be formed of only the plastic substrate 41 without the metal thin film 42 or may be formed of only a glass plate. In this case, electroless plating may be performed on a surface of a plastic or glass plate to form desired plating layers of the bus and black electrodes.

As shown in FIG. 4B, a photoresist 43 may be coated on an entire upper surface of the metal thin film 42. The photoresist 43 may be a negative photoresist.

As shown in FIG. 4C, the photoresist 43 may be exposed to light.

When a mask 45 is disposed on an entire surface of the photoresist 43 and the negative photoresist is exposed to light from a light source 57, hatched portions 43a of the negative photoresist that are not exposed to the light are softened. Accordingly, when development is subsequently performed, a portion of the photoresist 43 corresponding to the hatched portions 43a may be removed to form predetermined patterns 47 having plating grooves 52 therebetween, as shown in FIG. 4D.

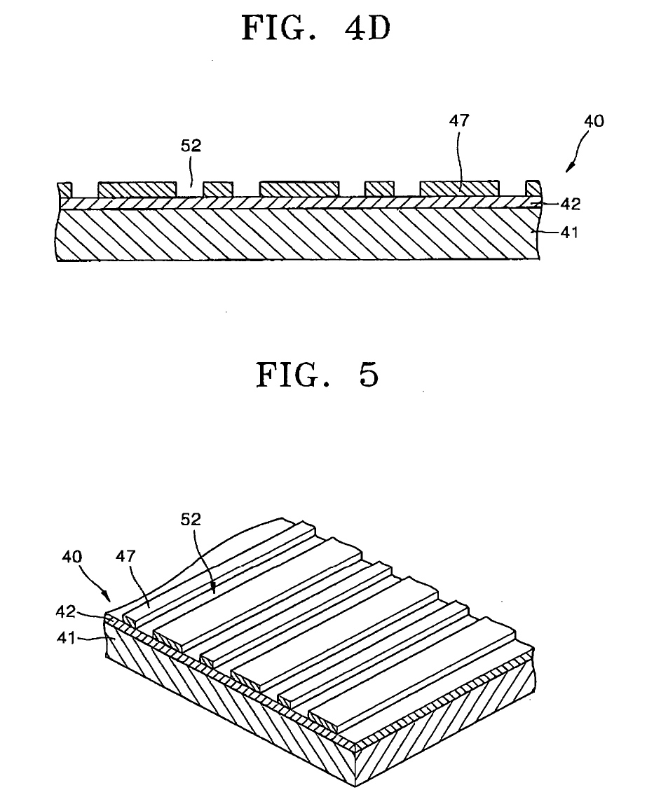

FIG. 5 illustrates a schematic perspective view of a mold plate formed through the processes described with reference to FIGS. 4A through 4D. Referring to FIG. 5, photoresist patterns 47 may be formed on a surface of the mold plate 40, and plating grooves 52 may be formed between the photoresist patterns 47. As will be described later, electrode patterns may be formed by plating the plating grooves 52 with the bus and the black electrode material.

According to another aspect of the present invention, patterns of a mold plate may be formed using a photosensitive glass paste instead of a photoresist. For example, the photosensitive glass paste may be coated instead of the photoresist 43 of FIG. 4B, and the light-exposure and the development may be performed so as to form glass patterns as shown in FIG. 5. According to another aspect of the present invention, a mold plate may be formed using a glass frit or a ceramic frit. If the mold plate is formed using glass frit or ceramic frit, the mold plate may be used repeatedly.

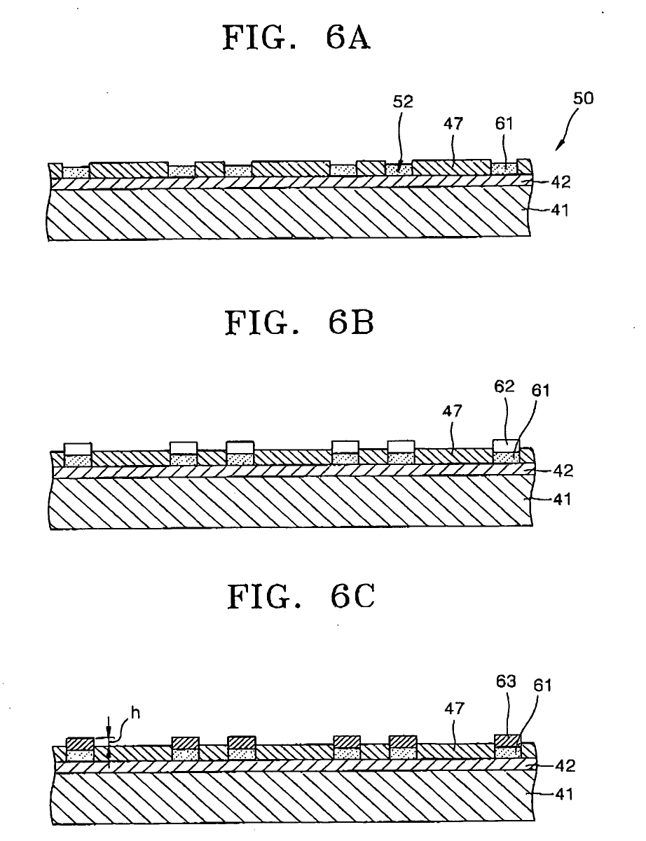

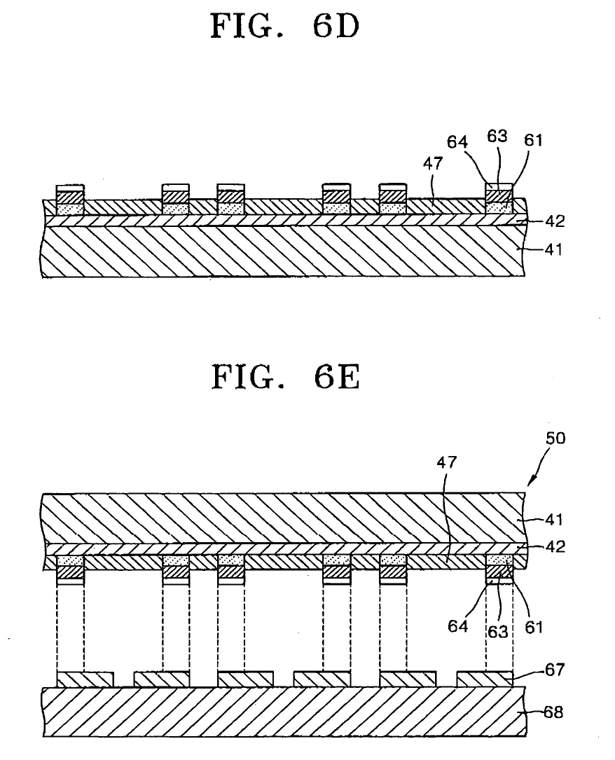

FIGS. 6A through 6E illustrate schematic cross-sectional views of stages in a method of manufacturing bus and black electrodes using a mold plate. Referring to FIG. 6A, plating grooves 52 may be formed in a mold plate 50, and first plating layers 61, e.g., Ag plating layers, may be formed in the plate grooves 52. The first plating layers 61 may be formed using a general method. For example, an AgCN plating solution may be used as a plating solution, and a metal thin film of the mold plate 50 may be used as an electrode for plating so as to form the first plating layers 61. According another aspect of the present invention, if a metal thin film is not formed, a seed layer may be formed using electroless plating, and then plating may be performed so as to form the first plating layers 61. The first plating layers 61 may not be thicker than depths of the plate grooves 52. As will be described later, the first plating layers 61 may serve as bus electrodes of a plasma display panel.

Referring to FIG. 6B, second plating layers 62, e.g., copper (Cu) or nickel phosphorous (Ni—P), may be formed on the first plating layers 61. Here, the second plating layers 62 may extend slightly above the photoresist patterns 47 forming the plate grooves 52. This extension above the photoresist patterns 47 may prevent patterns 47 from interfering with each other during transfer of electrodes. In other words, if upper surfaces of the second plating layers 62 are lower than that of the patterns 47 forming the plating grooves 52, upper surfaces of the patterns 47 may contact the display electrodes during transfer. Thus, upper surfaces of the second plating layers 62 are preferably higher than the upper surfaces of the patterns 47. As shown in FIG. 6C, a thickness h between upper surfaces of the second plating layers 62 and upper surfaces of the patterns 47 forming the plating grooves 52 may be within a range between about 1 μm to about 5 μm. The second plating layers 62 may be formed using a general plating method.

Referring to FIG. 6C, the second plating layers 62 may be treated to form blackened second plating layers 63. If the second plating layers 62 are formed of Cu, the second plating layers 62 may be blackened using an alkaline blackening solution. If the second plating layers 62 are formed of Ni—P, the second plating layers 62 may be blackened using an acid blackening solution.

Referring to FIG. 6D, an adhesive material 64, e.g., an adhesive frit, may be coated on the second plating layers 63 that have been blackened. The adhesive material 64 may used to secure plating layers to display electrodes 67 on a front glass substrate 68, as shown in FIG. 6E. For example, the adhesive material 64 may be coated on the second plating layers 62 by a printing method using a mask.

Referring to FIG. 6E, the first plating layers 61 and the blackened second plating layers 63 may be transferred to the display electrodes 67 on the front glass substrate 68. After the first plating layers 61 and the blackened second plating layers 63 are transferred to and secured to upper surfaces of the display electrodes 67, e.g., through the adhesive material 64, the mold plate 50 may be removed. As a result, the first plating layers 61 may serve as the bus electrodes and the blackened second plating layers 63 may serve as black electrodes on the display electrodes 68. Thereafter, a dielectric layer and a protection layer may be formed on the front glass substrate 68, as shown in FIG. 2.

If the mold plate 50 is formed of a flexible plastic material, the mold plate 50 may be easily removed after plating layers are transferred. In other words, the mold plate 50 may be slightly bent and, thus, easily removed.

When the blackened second plating layers 63 are not formed, the processes described with reference to FIGS. 6A through 6E may still be applied for just the first plating layer 61. For example, when black stripes are realized by other means than black electrodes or are not necessary, the blackened second plating layers 63 may not be formed. In this case, thicknesses of the first layers 61 may be equal to or greater than thicknesses of patterns 47 of a mold plate. Also, the adhesive material 64 may be directly coated on the upper surface of the first plating layers 61 to be transferred to the display electrodes 67.

As described above, in a method of manufacturing opaque electrodes of a plasma display panel, a mold plate used in the method, and the plasma display panel with the opaque electrodes manufactured thereby, an amount of material used to manufacture the opaque electrodes may be reduced. Also, the opaque electrodes can be quickly and simply manufactured.

Exemplary embodiments of the present invention have been disclosed herein, and although specific terms are employed, they are used and are to be interpreted in a generic and descriptive sense only and not for purpose of limitation. For example, the adhesive material may be applied to the display electrode rather than to the plating layers on the mold. Accordingly, it will be understood by those of ordinary skill in the art that various changes in form and details may be made without departing from the spirit and scope of the present invention as set forth in the following claims.

What is claimed is:

1. A method of manufacturing opaque electrodes of a plasma display panel, the method comprising:
providing a mold plate having plating grooves corresponding to patterns of the opaque electrodes of the plasma display panel;
forming first plating layers in the plating grooves;
transferring the first plating layers to display electrodes on a substrate; and
removing the mold plate, leaving the first plating layers on the display electrodes.

2. The method as claimed in claim 1, wherein the first plating layers are Ag plating layers.

3. The method as claimed in claim 1, wherein providing the mold plate includes providing a metal film on a material plate and forming the plating grooves on the metal film.

4. The method as claimed in claim 3, wherein the metal film is one of stainless steel, titanium, nickel and iron.

5. The method as claimed in claim 1, wherein providing the mold plate includes forming a seed layer for electroless plating before forming the first plating layers.

6. The method as claimed in claim 1, wherein the plating grooves are formed in a photoresist.

7. The method as claimed in claim 1, wherein the plating grooves are formed by a photoresist paste.

8. The method as claimed in claim 1, further comprising providing an adhesive material between the first plating layers and the display electrodes before transferring.

9. The method as claimed in claim 1, further comprising, before transferring, forming second plating layers on upper surfaces of the first plating layers, the transferring including transferring the first and second plating layers.

10. The method as claimed in claim 9, wherein the first plating layers are Ag plating layers, and the second plating layers are copper or Ni—P plating layers.

11. The method as claimed in claim 9, further comprising, before transferring, blackening the second plating layers.

12. The method as claimed in claim 11, wherein the second plating layers are copper plating layers and blackening includes using an alkaline blackening solution.

13. The method as claimed in claim 11, wherein the second plating layers are Ni—P plating layers and blackening includes using an acid blackening solution.

14. The method as claimed in claim 1, wherein the mold plate includes a glass material plate.

15. The method as claimed in claim 1, wherein the mold plate includes a plastic material plate.

16. A mold plate used for manufacturing opaque electrodes of a plasma display panel, the mold plate comprising:
a plate; and
patterns formed on an upper surface of the plate including plating grooves corresponding to the opaque electrodes of the plasma display panel.

17. The mold plate as claimed in claim 16, wherein the plate is one of a plastic plate, a plastic plate having a metal layer thereon, a glass plate and a ceramic plate.

18. The mold plate as claimed in claim 16, wherein the patterns are formed of one of a photoresist and a photosensitive glass paste.

19. A plasma display panel, comprising:
display electrodes;
bus electrodes; and
an adhesive material between the display electrodes and the bus electrodes.

20. The plasma display panel as claimed in claim 19, further comprising black electrodes between the adhesive material and the bus electrodes.
